(19) United States
(12) Patent Application Publication
(10) Pub. No.: US 2011/0255839 A1
(43) Pub. Date: Oct. 20, 2011

(54) IMPORTING BLU-RAY DISC CONTENT

(75) Inventors: Stephen Watson, Toronto (CA); Paul Rechsteiner, Toronto (CA); Lee Payne, Waterloo (CA); Kevin Hui, Sunnyvale, CA (US); Tom Barnett, Sunnyvale, CA (US)

(73) Assignee: KALEIDESCAPE, INC., Sunnyvale, CA (US)

(21) Appl. No.: 13/088,250

(22) Filed: Apr. 15, 2011

Related U.S. Application Data
(60) Provisional application No. 61/324,676, filed on Apr. 15, 2010.

(51) Int. Cl. H04N 5/775; H04N 5/765

(52) U.S. Cl. 386/230; 386/231; 386/E05.07; 386/E05.002

(57) ABSTRACT

A system is described, which includes an optical drive and a media server. The media server includes a storage device, and is coupled to the optical drive. The media server is configured to determine whether the optical drive contains an optical disc associated with digital content, and is further configured to receive a request for access to the digital content.

### CROSS REFERENCE TO RELATED APPLICATIONS

This application claims priority to and the benefit under 35 U.S.C. §119(e) of copending U.S. Provisional Patent Application No. 61/324,676, entitled “IMPORTING BLU-RAY DISC CONTENT” by Watson et al., filed on Apr. 15, 2010, which is hereby incorporated by reference as if fully set forth herein.

### BACKGROUND

1. Field of the Invention

Embodiments of the present invention relate to importing Blu-ray disc content.

2. Related Art

Importing Blu-ray disc content involves different and additional steps, as compared to importing DVD content.

### SUMMARY

A system is described, which includes an optical drive and a media server. The media server includes a storage device, and is coupled to the optical drive. The media server is configured to determine whether the optical drive contains an optical disc associated with digital content, and is further configured to receive a request for access to the digital content.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 depicts an exemplary computer system, upon which embodiments may be implemented.

FIG. 2 depicts an exemplary media server environment, in accordance with one embodiment.

FIG. 3 depicts an exemplary media server environment, in accordance with one embodiment.

FIG. 4 depicts a distributed media server environment, in accordance with one embodiment.

FIG. 5 depicts a method of importing and playing digital content, in accordance with one embodiment.

FIG. 6 depicts a disc presence monitoring system, in accordance with one embodiment.

FIG. 7 depicts a method of disc presence monitoring, in accordance with one embodiment.

FIG. 8 depicts a method of utilizing a disc vault, in accordance with one embodiment.

FIG. 9 depicts a method of importing digital content, in accordance with one embodiment.

### DETAILED DESCRIPTION

Reference will now be made in detail to several embodiments of the invention. While the invention will be described in conjunction with the alternative embodiment(s), it will be understood that they are not intended to limit the invention to these embodiments. On the contrary, the invention is intended to cover alternative, modifications, and equivalents, which may be included within the spirit and scope of the invention as defined by the appended claims.

Furthermore, in the following detailed description, numerous specific details are set forth in order to provide a thorough understanding of the claimed subject matter. However, it will be recognized by one skilled in the art that embodiments may be practiced without these specific details or with equivalents thereof. In other instances, well-known methods, procedures, components, and circuits have not been described in detail as not to unnecessarily obscure aspects and features of the subject matter.

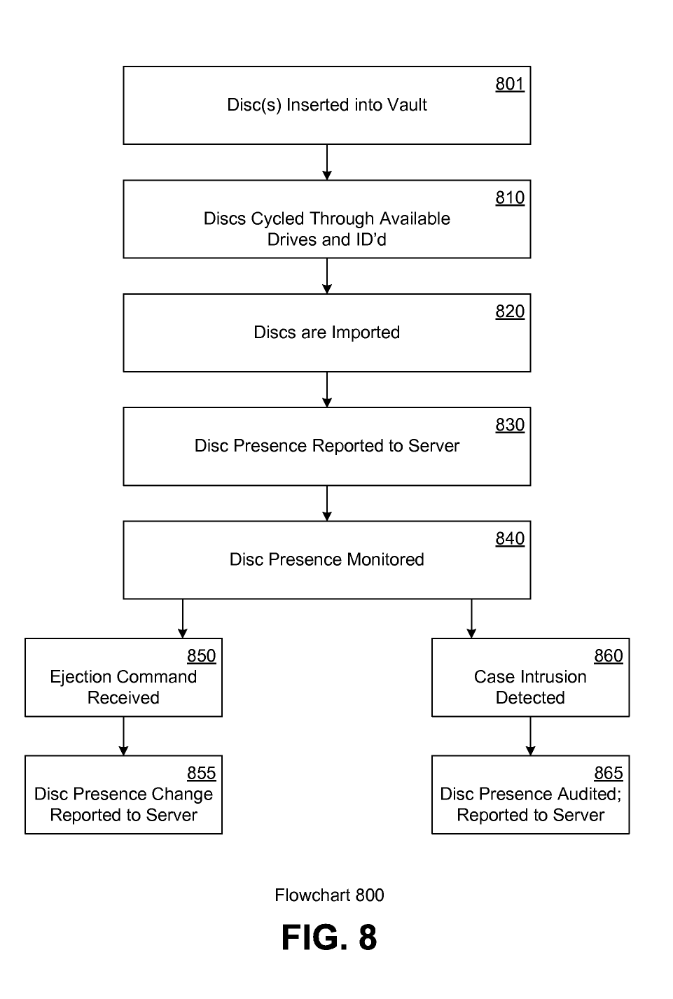

Portions of the detailed description that follows are presented and discussed in terms of a method. Although steps and sequencing thereof are disclosed in figures herein (e.g., FIG. 8) describing the operations of this method, such steps and sequencing are exemplary. Embodiments are well suited to performing various other steps or variations of the steps recited in the flowchart of the figure herein, and in a sequence other than that depicted and described herein.

Some portions of the detailed description are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer-executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout, discussions utilizing terms such as “accessing,” “writing,” “including,” “storing,” “transmitting,” “traversing,” “associating,” “identifying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Computing devices typically include at least some form of computer readable media. Computer readable media can be any available media that can be accessed by a computing device. By way of example, and not limitation, computer readable medium may comprise computer storage media and communication media. Computer storage media includes volatile and nonvolatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other medium which can be used to store the desired information and which can be accessed by a computing device. Communication media typically embodies computer readable instructions, data structures, program modules, or other data in a modulated data signals such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer readable media.

Some embodiments may be described in the general context of computer-executable instructions, such as program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

### Basic Computing System

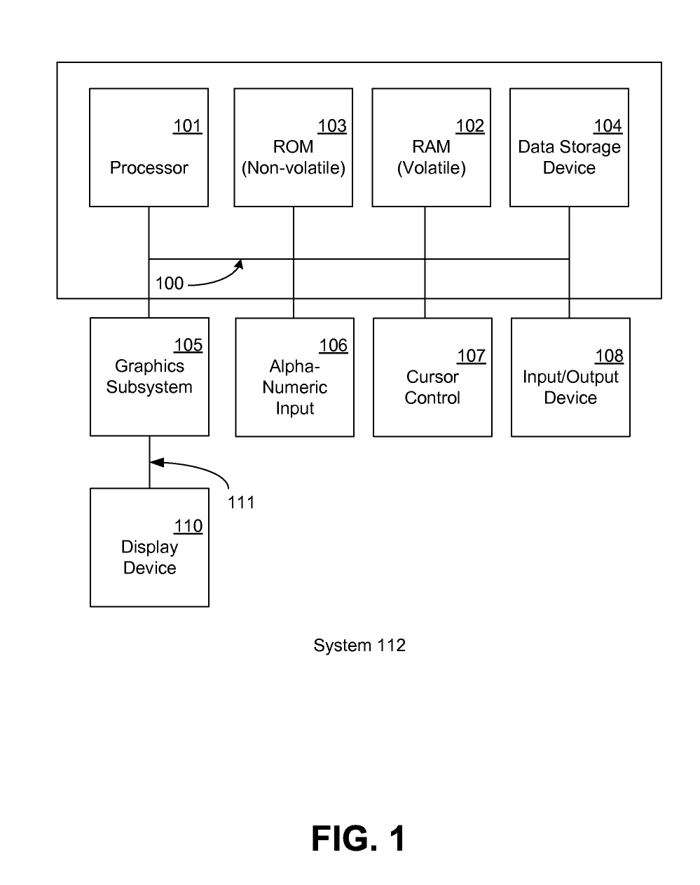

Referring now to FIG. 1, a block diagram of an exemplary computer system 112 is shown. It is appreciated that computer system 112 described herein illustrates an exemplary configuration of an operational platform upon which embodiments may be implemented to advantage. Nevertheless, other computer systems with differing configurations can also be used in place of computer system 112 within the scope of the present invention. For example, computer system 112 may include additional, fewer, or different elements other than those described in conjunction with FIG. 1. Moreover, embodiments may be practiced on any system which can be configured to enable it, not just computer systems like computer system 112. It is understood that embodiments can be practiced on many different types of computer system 112. System 112 can be implemented as, for example, a desktop computer system or server computer system having a powerful general-purpose CPU coupled to a dedicated graphics rendering GPU. In such an embodiment, components can be included that add peripheral buses, specialized audio/video components, IO devices, and the like. Similarly, system 112 can be implemented as a handheld device (e.g., cellphone, etc.) or a set-top video game console device such as, for example, the Xbox®, available from Microsoft Corporation of Redmond, Wash., or the PlayStation3®, available from Sony Computer Entertainment Corporation of Tokyo, Japan. System 112 can also be implemented as a “system on a chip”, where the electronics (e.g., the components 101, 103, 105, 106, and the like) of a computing device are wholly contained within a single integrated circuit die. Examples include a hand-held instrument with a display, a car navigation system, a portable entertainment system, and the like.

Computer system 112 comprises an address/data bus 100 for communicating information, a central processor 101 coupled with bus 100 for processing information and instructions; a volatile memory unit 102 (e.g., random access memory [RAM], static RAM, dynamic RAM, etc.) coupled with bus 100 for storing information and instructions for central processor 101; and a non-volatile memory unit 103 (e.g., read only memory [ROM], programmable ROM, flash memory, etc.) coupled with bus 100 for storing static information and instructions for processor 101. Moreover, computer system 112 also comprises a data storage device 104 (e.g., hard disk drive) for storing information and instructions.

Computer system 112 also comprises an optional graphics subsystem 105, an optional alphanumeric input device 106, an optional cursor control or directing device 107, and signal communication interface (input/output device) 108. Optional alphanumeric input device 106 can communicate information and command selections to central processor 101. Optional cursor control or directing device 107 is coupled to bus 100 for communicating user input information and command selections to central processor 101. Signal communication interface (input/output device) 108, which is also coupled to bus 100, can be a serial port. Communication interface 108 may also include wireless communication mechanisms. Using communication interface 108, computer system 112 can be communicatively coupled to other computer systems over a communication network such as the Internet or an intranet (e.g., a local area network), or can receive data (e.g., a digital television signal). Computer system 112 may also comprise graphics subsystem 105 for presenting information to the computer user, e.g., by displaying information on an attached display device 110, connected by a video cable 111. In some embodiments, graphics subsystem 105 is incorporated into central processor 101. In other embodiments, graphics subsystem 105 is a separate, discrete component. In other embodiments, graphics subsystem 105 is incorporated into another component. In other embodiments, graphics subsystem 105 is included in system 112 in other ways.

### Exemplary Media Server Environment

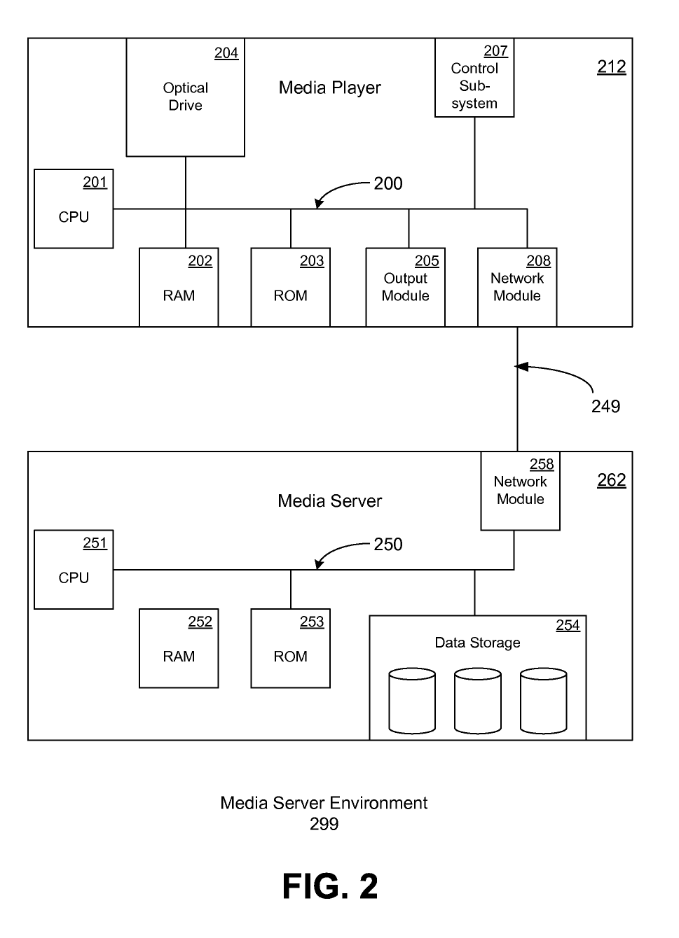

With reference now to FIG. 2, an exemplary media server environment 299 is depicted, in accordance with one embodiment. While media server environment 299 is shown as incorporating specific, enumerated features and elements, it is understood that embodiments are well suited to applications having additional, fewer, or different arrangements of features or elements. For example, the functionality described herein may be incorporated into a single physical device, or spread across additional devices.

Media server environment 299 is shown as comprising two devices: media player 212, and media server 262. Media player 212 includes: bus 200 for communicating information; a central processor 201 coupled with bus 200 for processing information and instructions; a volatile memory unit 202 (e.g., random access memory [RAM], static RAM, dynamic RAM, etc.) coupled with bus 200 for storing information and instructions for central processor 201; and a non-volatile memory unit 203 (e.g., read only memory [ROM], programmable ROM, flash memory, etc.) coupled with bus 200 for storing static information and instructions for processor 201. Moreover, media player 212 incorporates optical drive 204, coupled with bus 200, for accessing data stored on optical media, e.g., CDs or DVDs. Media player 212 also incorporates output module 205, coupled with bus 200, for outputting audio and/or video data. Media player 212 is also shown as incorporating networking module 208, coupled with bus 200, for transmitting and receiving information, e.g., over a network connection. In the depicted embodiment, media player 212 also incorporates control subsystem 207. Control subsystem 207 is coupled with bus 200, and receives control signals for controlling the functionality of media player 212, as well as for manipulating digital content being played on media player 212.

As shown in the depicted embodiment, media player 212 is communicatively coupled to media server 262 via network connection 249. In different embodiments, network connection 249 may be implemented in different ways. For example, network connection 249 may be implemented as a TCP/IP connection, transmitted via Ethernet or a wireless connection.

Media server 262 includes: bus 250 for indicating information; a CPU 251 coupled with bus 250 for processing information and instructions; a volatile memory unit 252 (e.g., random access memory [RAM], static RAM, dynamic RAM, etc.) coupled with bus 250 for storing information and instructions for central processor 251; and a non-volatile memory unit 253 (e.g., read only memory [ROM], programmable ROM, flash memory, etc.) coupled with bus 250 for storing static information and instructions for processor 251. Media server 262 also includes data storage device 254, depicted here as a RAID array (redundant array of inexpensive disks), coupled with bus 250 for storing digital media content. Media server 262 further includes networking module 258, coupled with bus 250, for transmitting and receiving information, e.g., over a network connection.

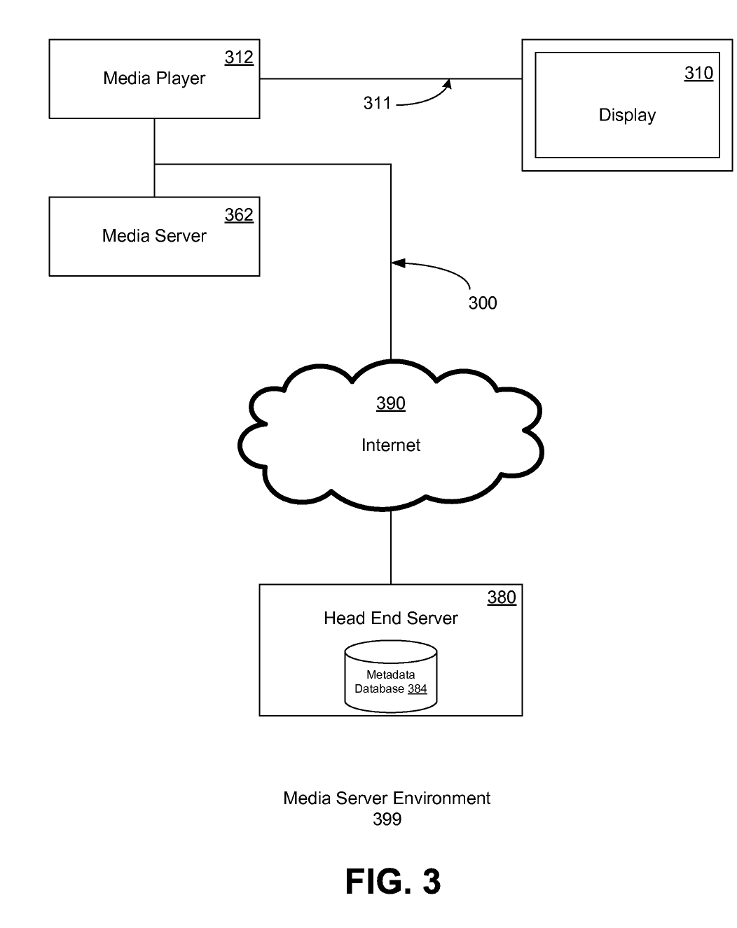

With reference now to FIG. 3, an exemplary media server environment 399 is depicted, in accordance with one embodiment. While media server environment 399 is shown as incorporating specific, enumerated features and elements, it is understood that embodiments are well suited to applications having additional, fewer, or different arrangements of features or elements. For example, the functionality described herein may be incorporated into a single physical device, or spread across additional devices.

In the depicted embodiment, media server 362 is used to store digital media content. Media server 362 is communicatively coupled with media player 312 via network connection 300. Media player 312, in the depicted embodiment, retrieves digital media content from server 362 and plays it back, e.g., by outputting digital video content over video cable 311 to display 310. Media server 362 is also communicatively coupled to a head end database 380, via network connection 300, and the Internet 390. Head end database 380 includes metadata database 384. Media server 362, in this embodiment, is configured to retrieve metadata corresponding to digital content from metadata database 384.

In different embodiments, digital media content may be available from sources other than media server 362. In one such embodiment, for example, media server 362 and/or media player 312 may be able to access or download digital media content from a remote source, e.g., head end database 380, or a remote digital media storage device (not pictured). Similarly, in some embodiments, digital media content may be available in accordance with a digital rights management (DRM) scheme, such as a “rental” scenario where digital media content is available to be viewed for a fixed length of time, or for a specified number of playbacks.

### Distributed Media Server Environment

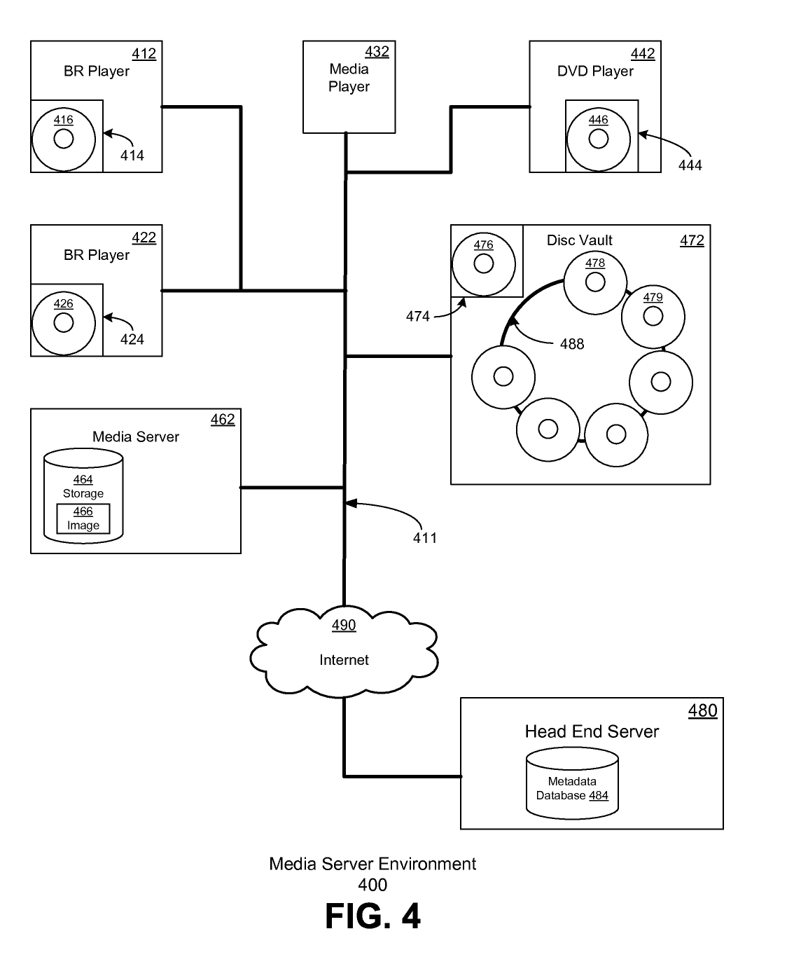

With reference now to FIG. 4, a distributed media server environment 400 is depicted, in accordance with one embodiment. While environment 400 is shown as containing specific, enumerated features, elements, and arrangements, it is understood that embodiments are well suited to environments containing additional, fewer, or different features, elements, or arrangements. In particular, in some embodiments, the described media player functionality, media server functionality, and/or disc vault functionality may be incorporated into a single device.

Environment 400 is depicted as including: network 411; Blu-ray player 412, which contains blue laser optical drive 414 and disc 416; Blu-ray player 422, which contains blue laser optical drive 424 and disc 426; media player 432; DVD player 442, which contains DVD optical drive 444 and disc 446; media server 462, which includes storage element 464, containing image 466; disc vault 472, which includes blue laser optical drive 474, and a plurality of discs including disc 476, 478, and 479, disposed on carousel mechanism 488; head end server 480, containing metadata database 484; and Internet 490.

Environment 400, in the depicted embodiment, is a representation of a distributed media server environment. It contains several media players of various types, such as Blu-ray players 412 and 422, media player 432, and DVD player 442. Each of these media players would be connected to one or more presentation devices, such as television displays, computer monitors, or projectors. Environment 400 is also depicted as including disc vault 472; vault 472 is a multidisc storage device and reader; in some embodiments, vault 472 may also have media player functionality. Environment 400 is also shown as including media server 462, which includes storage element 464. The media players included in environment 400 communicate with media server 462 via network 411; network 411 is often an Ethernet network, but may be any suitable data transfer network. In the depicted embodiment, network 411 is connected to head end server 480, by way of Internet 490. Head end server 480 includes metadata database 484.

### Importing Blu-ray Content

In a media server environment, such as environment 400, it is often useful to import the content stored on removable media such as DVDs or Blu-ray discs to a media server. This allows content to be accessed by any of the media players distributed throughout the environment. Additionally, metadata can be associated with the content, which allows a user accessing a media player to make use of metadata, e.g., looking at cover art, reading a plot synopsis, or seeing which actors starred in a particular film.

Several methods are available for importing the content stored on a piece of removable media to a media server. One approach involves making an ISO image of the media object, and copying that image to storage located on, or accessible to, the media server. Another approach involves copying all the files stored on the media to the media server. Both of these approaches leave whatever encryption schemes that are in use on the media intact; for example, the CSS encryption used on commercial DVDs is not decrypted when the files on the DVD are copied to the media server. A third approach involves first decrypting the content on the media object, and then copying the decrypted content to the media server. In some cases, the decrypted content is re-encrypted on the media server, using the same or a different encryption technique; or re-encrypting or transforming the encryption as the content is read, before transferring the content over a network connection. This third approach may be appropriate in a Managed Copy implementation for Blu-ray discs. In some embodiments, certain data may not be copied off of the media object, either for technical or licensing reasons; also, certain data may receive additional encryption before it is transferred over a network or stored on a media server.

In the depicted embodiment, Blu-ray players 412 and 422 are each shown as including blue laser optical drives 414 and 424, respectively; disc vault 472 similarly includes blue laser optical drive 474. DVD player 442 is shown as including DVD optical drive 444. In the depicted embodiment, blue laser optical drives include the functionality necessary to read Blu-ray discs, DVDs, CDs, and similar storage media, while DVD optical drives lack the necessary functionality to read Blu-ray discs.

### Playing Imported Content

Once content has been imported into a media server, the media players in a media server environment, such as environment 400, can be used to access the content. In order for a given media player to access a particular piece of content, however, the media player needs to be capable of decrypting and/or decoding the content for playback. In the case of Blu-ray content and DVD players, most DVD players lacked the necessary hardware to decrypt Blu-ray content, or to decode the content after decryption for playback.

For example, with reference to FIG. 4, if image 466 corresponds to Blu-ray content, DVD player 442 will not be able to decrypt or decode the image for playback.

In some embodiments, in addition to this technical requirement, technology licensing terms may impose additional requirements. For example, the AACS license applies to most manufacturers of Blu-ray players, and provides for a “move” process. One allowable “move” process requires that content that is usable by only a given device is effectively rendered unusable by that device and is rendered usable in association with only a single instance of removable storage medium, only in such manner that the content is never simultaneously usable both by the device and in association with such instance of removable storage medium (except where such instance of removable storage medium is reinserted in such device to render such content useable in association with such removable storage medium). Another allowable “move” process requires that content that is usable in association only with a single instance of a given removable storage medium is rendered unusable in association with that instance of removable storage medium and is rendered usable by a single device, only in such manner that the content is never simultaneously usable both in association with the instance of removable storage medium and by the device (except where such instance of removable storage medium is reinserted in such device to render such content useable by such device). Another “move” process may involve the destruction of content, in order to effectively render it unusable; for example, content may be “moved” from the original distribution medium, such as an optical disc, to a storage medium, and then the original distribution medium may be destroyed, overwritten, or otherwise rendered unusable, leaving only the “moved” copy on the storage medium.

In a media server environment, such as environment 400, these license terms may be complied with by ensuring that the media object from which the image stored on the media server was made is present in the environment, before allowing access to the image. For example, if image 466 corresponds to Blu-ray disc 416, currently located in Blu-ray player 412, then any capable media player in media server environment 400 may access image 466. However, if Blu-ray disc 416 is removed from Blu-ray player 412, image 466 should not be available to media players in environment 400. In such an embodiment, the “content that is usable only by a given device” is the image stored on media server 462, while the “removable storage medium” is Blu-ray disc 416. For another example, the move may result in a usable copy being made of a media object onto the media server, so that one or both of the media object, or the copy of it stored on the media server, are effectively and uniquely associated (using a cryptographic protocol or other effective means) with one product, so that such media object or copy cannot be accessed in usable form by another product, except as and when passed to an output.

In some embodiments, monitoring the absence or presence of Blu-ray discs within a media server environment is accomplished using a disc presence monitoring system, such as that described below. In other embodiments, another approach may be utilized to monitor for the absence or presence of media objects.

In some embodiments, other methods of ensuring that a media object is unusable while an image is usable may be utilized. One such embodiment utilizes a disc vault, such as disc vault 472. This embodiment is described in greater detail, below.

While many of the embodiments described herein discuss specific technologies, such as Blu-ray discs, DVDs, and associated hardware for reading, decrypting, and decoding such discs, it is understood that embodiments are well suited for applications involving different technologies. Moreover, one having skill in the art will recognize that discussion of Blu-ray discs, DVDs, and CDs extends to discussions of the variations on these formats, such as CD-Rs, CD-RW, DVD-R, DVD+R, DVD-RW, DVD+RW, BD-R, BD-RW, and others.

### Method of Importing and Playing Digital Content

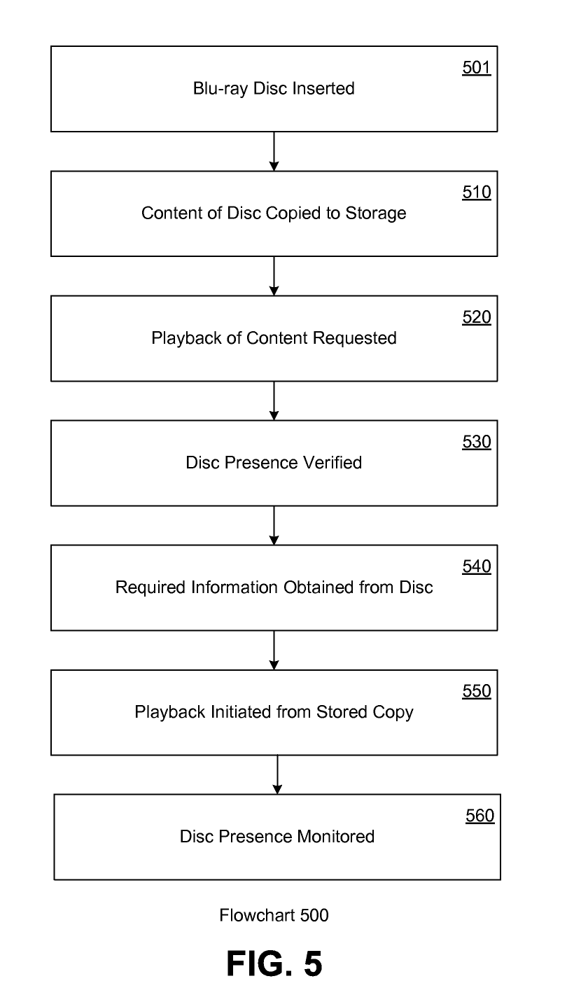

With reference now to FIG. 5, a flowchart 500 of a method of importing and playing digital content is depicted, in accordance with one embodiment. Although specific steps are disclosed in flowchart 500, such steps are exemplary. That is, embodiments of the present invention are well suited to performing various other (additional) steps or variations of the steps recited in flowchart 500. It is appreciated that the steps in flowchart 500 may be performed in an order different than presented, and that not all of the steps in flowchart 500 may be performed.

With reference now to step 501, a Blu-ray disc is inserted into a media player within a media server environment. As noted above, in different embodiments different technologies may be utilized; embodiments are well suited to applications involving technologies other than Blu-ray discs.

For example, with reference to FIG. 4, Blu-ray disc 416 is inserted into blue laser optical drive 414 of Blu-ray player 412.

With reference now to step 510, the content contained on the Blu-ray disc is imported to a media server in the media server environment. As previously discussed, different methods may be utilized for importing or copying content to a media server; this includes approaches such as creating an ISO image (or other methods of packaging the entire disc image), copying the files stored on the disc, or decrypting the content on the disc and storing it in a storage location on the media server.

Continuing the example, the content of Blu-ray disc 416 is copied to media server 462, and stored in storage element 464 as image 466.

With reference now to step 520, playback of the content stored on the media server is requested. In different embodiments, different approaches may be utilized for requesting playback of content. In one embodiment, a media player within a media server environment is used to select from content available on the media server, and request playback of particular content on that media player. As discussed above, different media players within the media server environment may have limitations as regards which content they are allowed to access, e.g., a media player without the necessary hardware to decrypt and/or decode Blu-ray content may be prevented from requesting playback of stored content derived from Blu-ray discs.

Continuing the preceding example, media player 432 is used to request playback of the content associated with image 466.

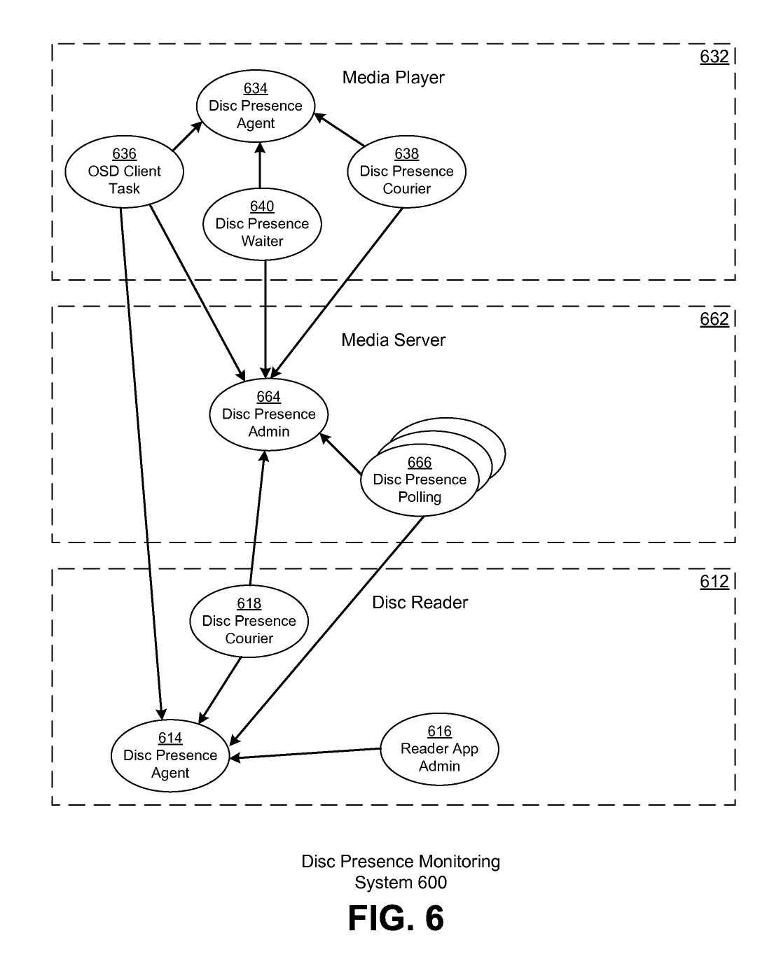

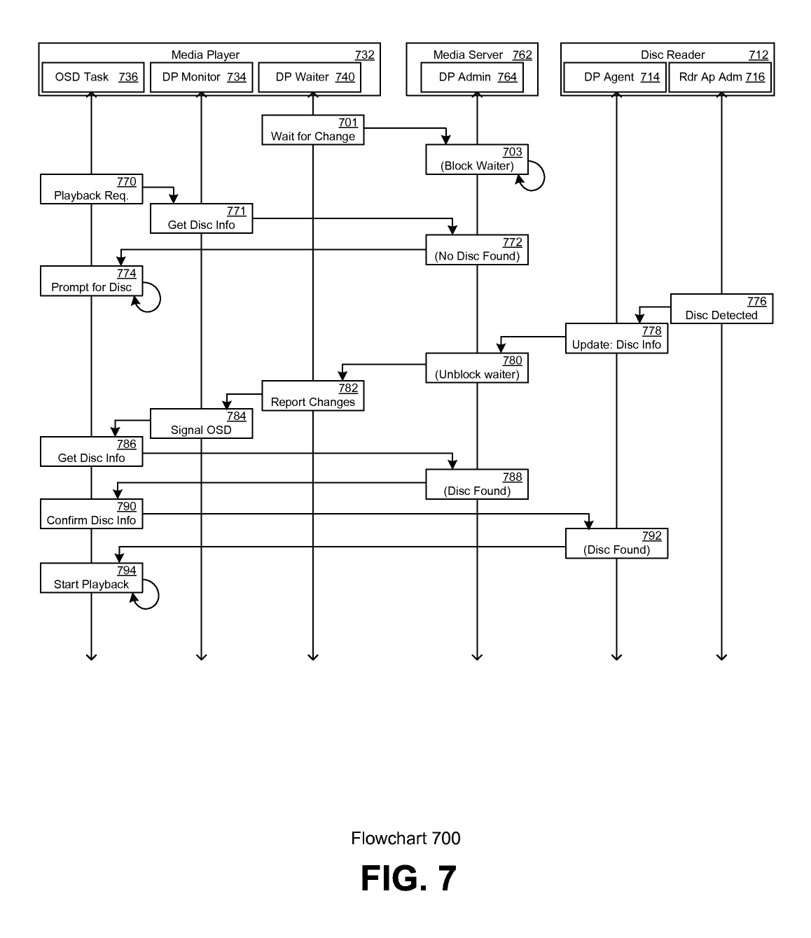

With reference now to step 530, the presence of the Blu-ray disc is verified. As discussed above, in some embodiments it is desirable for the physical disc to remain available in the media server environment, if the copy of the content of the disc is to be usable. In different embodiments, different approaches are utilized; one such approach is described in greater detail below, with reference to FIGS. 6 and 7. In other embodiments, other approaches are utilized to verifying disc presence within the media server environment. In some embodiments, if disc presence cannot be verified, playback of the stored content is prohibited; in other embodiments, if disc presence cannot be verified, limitations may be placed on playback of the stored content, e.g., only some portion of the stored content, such as a movie trailer, may be accessible for playback, or playback of content may be limited to a certain number of viewings without the disc present. In different embodiments, disc presence verification may occur at different times. In one embodiment, disc presence may be verified “on demand,” when playback of content is requested. In another, disc presence verification may be an ongoing process, such that a media player and/or media server has a list of discs which are present within the environment; such a list may be updated whenever an action occurs which changes the presence of a disc (such as an “eject disc” command received on a media player within the environment or a portion of the environment becomes unavailable, e.g., because of network or power interruptions), and/or be subject to periodic auditing for disc presence. In some embodiments, if disc presence cannot be verified, a message may be displayed indicating that the disc should be inserted; this message may also include information on where the disc may be located, if the information is available; e.g., “Binder 4, pg. 2, in Living Room;” this message may indicate which media server environment element the disc should be inserted into.

Continuing the preceding example, media server 460 verifies that disc 416 is present in media server environment 400.

With reference now to step 540, additional information is obtained from the Blu-ray disc. In some embodiments, some specified information may not be copied from the Blu-ray disc to the media server, e.g., information such as a Volume ID. In several such embodiments, this specified information is useful or necessary for the decrypting, decoding, or playback of the stored content. Such specified information may not be copied to the media server for technical reasons, or for licensing reasons. In one embodiment, this specified information is read by the Blu-ray player, e.g., during disc identification or importation, and cached or otherwise stored for ready access when playback is requested; similarly, in an embodiment which incorporates a disc vault, the vault may cache the specified information for each disc stored in the vault. In other embodiments, this step is omitted.

Continuing the preceding example, media server 462 requests additional information from disc 416, for use in decrypting and/or decoding image 466 for playback. Blu-ray player 412 uses optical drive 414 to access disc 416, and provides this specified information.

With reference now to step 550, playback of the requested content is initiated. In some embodiments, once disc presence is verified anywhere in the media server environment, any media player may begin playback of the stored content on the media server.

Continuing the preceding example, media server 462 streams image 466 to media player 432. Media player 432 decrypts and decodes image 466, and outputs the resulting video stream to a presentation device.

With reference now to step 560, disc presence continues to be monitored. As noted above, in different embodiments, different approaches are utilized to monitor disc presence. In some embodiments, disc presence must continue, if the stored content is to be usable. If the disc becomes unavailable, the stored content is rendered unusable by the media server. This may result in termination of playback of the stored content, in some embodiments; in others, the user may receive a notification message, or playback may be allowed to continue for a period of time, e.g., 5 minutes, terminating only if the disc does not become available within that period. In one such embodiment, if playback is terminated in this fashion, a “pause” bookmark is created to allow resumption of playback at the termination point; a message notifying the user of the reason for termination of playback may also be displayed.

Continuing the preceding example, media server 462 monitors the presence of disc 416. If disc 416 is removed from Blu-ray player 412, media server 462 terminates playback of the content stored in image 466.

### Disc Presence Monitoring

As previously noted, in some embodiments it is desirable to monitor the absence or presence of digital media, before and during playback of digital content associated with the digital media. In some embodiments, disc presence monitoring is accomplished by a combination of elements, operating across various components of the media server environment.

With reference now to FIG. 6, a disc presence monitoring system 600 is depicted, in accordance with one embodiment. While disc presence monitoring system 600 is shown as incorporating specific, enumerated features, elements, and arrangements, it is understood that embodiments are well suited to applications involving additional, fewer, or different features, elements, or arrangements. In particular, it is understood that the functionality of one or more of the modules described in conjunction with disc presence monitoring system 600 may be combined with other modules, or separated into multiple additional modules. Additionally, it is understood that the functionality performed by one or more of these modules may be implemented within different elements of a media server environment; alternatively, the functionality of multiple elements of the media server environment may be combined into fewer elements, e.g., a media player may also serve as a disc reader. In different embodiments, the functionality ascribed to the modules depicted in disc presence monitoring system 600 may be implemented as hardware elements, software elements, or combinations of both.

Disc presence monitoring system 600 is shown as including disc reader 612, media player 632, and media server 662. Disc reader 612 includes several modules: disc presence agent module 614, reader application admin module 616, and disc presence courier module 618. Media player 632 includes several modules: disc presence agent module 634, on-screen display client task module 636, disc presence courier module 638, and disc presence waiter module 640. Media server 662 includes several modules: disc presence administration module 664, and one or more disc presence polling modules 666.

In some embodiments, the elements and modules of disc presence monitoring system 600 are utilized to monitor the absence or presence of disc media, or the presence state of media, within a media server environment, e.g., by monitoring for the insertion or removal of such media, as well as detecting events which render media unavailable, such as a network or power outage within the media server environment.

Disc presence agent module 614 handles or monitors disc states for media available to disc reader 612. Module 614 receives notifications of changes to presence state, as detected by reader application admin module 616, and notifies disc presence administration module 664 in media server 662 of changes to disc state. Reader application admin module 616 detects changes in disc state for discs available to disc reader 612, such as insertion or ejection events; module 616 notifies module 614 when such changes occur. Disc presence courier module 618 is used by module 614 to communicate with disc presence administration module 664; disc presence courier module 618 sends updated disc presence information to administration module 664.

Disc presence agent module 634 handles or monitors disc states related to content playback or access requests within media player 632. Module 634 may maintain a list of presence state information, indicating disc media availability within the media server environment. Module 634 communicates with disc presence administration module 664 by way of disc presence courier module 638, and receives change notifications from disc presence administration module 664, dispatching disc state information to other modules or elements within the media server environment as needed. OSD client task module 636 receives requests for access to content associated with a particular disc; module 636 queries disc presence administration module 664 and/or disc presence agent module 614 and/or disc presence agent module 634 in order to determine if the particular disc associated with the requested content is present. Disc presence courier module 638 fetches or receives this information from disc presence administration module 664. Disc presence waiter module 640 is used by disc presence agent module 634 to wait for change information received from disc presence administration module 664.

Disc presence administration module 664 synchronizes information with disc presence agents throughout disc presence monitoring system 600, in order to keep an up-to-date list or database of disc presence information; administration module 664 notifies disc presence agents when changes occur, and receives notifications from disc presence agents when changes are detected. Administration module 664 handles and responds to queries for disc state information from media players. In some embodiments, e.g. a media server environment with multiple media servers, each media server will have an active disc presence administration module, but only one administration module will control the operation of the disc presence monitoring system. Disc presence polling modules 666 are used by administration module 664 to fetch disc presence information from disc presence agents throughout disc presence monitoring system 600, if necessary. In some embodiments, multiple polling modules 666 are included to prevent a single unresponsive disc presence agent from slowing down the entire system.

### Method of Disc Presence Monitoring

With reference now to FIG. 7, a flowchart 700 of a method of disc presence monitoring is depicted, in accordance with one embodiment. Although specific steps are disclosed in flowchart 700, such steps are exemplary. That is, embodiments of the present invention are well suited to performing various other (additional) steps or variations of the steps recited in flowchart 700. It is appreciated that the steps in flowchart 700 may be performed in an order different than presented, and that not all of the steps in flowchart 700 may be performed.

Flowchart 700 is depicted in a manner which indicates which elements, and which modules executing within those elements, of a disc presence monitoring system are performing which actions. In the depicted embodiment, the method involves actions taken by: disc reader 712, including disc presence agent module 714 and reader application admin module 716; media player 732, including disc presence monitor module 734, on-screen display task module 736, and disc presence waiter modules 740; and media server 762, including disc presence administration module 764.

With reference now to step 701, disc presence waiter module 740 informs disc presence administration module 764 that media player 732 is waiting for disc presence change information. In the depicted embodiment, disc presence monitoring is a constant task; elements of the disc presence monitoring system which are interested in disc change events may subscribe to a disc presence administration module, in order to be informed when such events occur.

With reference now to step 703, disc presence administration module 764 blocks the request from disc presence waiter 740. In the depicted embodiment, until a change in disc presence occurs, the disc presence administration module may suppress subscription requests until some disc presence change information is received relating to the subscription request.

With reference now to step 770, OSD task module 736 issues a playback request to disc presence monitor module 734. In some embodiments, a playback request may initiate with a user interacting with media player 732. If the user attempts to access content for which disc presence must be verified, e.g., by attempting to initiate playback of content associated with a Blu-ray disc, the OSD task module attempts to verify that the associated disc is present within the media server environment.

With reference now to step 771, if disc presence monitor module 734 cannot verify that the appropriate disc is present, module 734 requests disc presence information from disc presence administration module 764. In some embodiments, disc presence monitor module 734 maintains disc presence information regarding discs known to be available to the disc presence monitoring system; in other embodiments, module 734 does not maintain this information. If module 734 cannot verify that a disc is present, it may request disc presence information regarding a particular disc from disc presence administration module 764, e.g., by sending an identifier, such as a hash value, as part of a request for disc presence information.

With reference now to step 772, if disc presence administration module 764 cannot verify that the appropriate disc is available to the disc presence monitoring system, it informs OSD task module 736 that the appropriate disc is not available.

With reference now to step 774, OSD task module 736 prompts for insertion of or access to the appropriate disc corresponding to the content associated with the playback request. In different embodiments, media player 732 may react to the absence of a particular disc in different ways. In one such embodiment, OSD task module 736 is used to display a message to the user attempting to access content that the appropriate disc needs to be inserted to continue or enable playback; additionally, OSD task module 736 may provide location information as to where the disc may be located, if such information is available from media server 762; OSD task module 736 may also specify a particular disc reader where the appropriate disc should be inserted. In some embodiments, OSD task module 736 may continue to display this message until the playback request is canceled, or until the method continues to perform.

With reference now to step 776, reader application admin module 716 detects insertion of a disc, and reports this change in disc presence to disc presence agent module 714. In some embodiments, reader application administration module 716 may also be able to provide additional disc information, e.g., an identifier or hash value corresponding to the inserted disc.

With reference now to step 778, disc presence agent module 714 informs disc presence administration module 764 of a change in disc presence status. In some embodiments, disc presence agent module 714 also provides additional disc information, such as a disc identification, identifier, or hash value.

With reference now to step 780, disc presence administration module 764 unblocks the subscription request from disc presence waiter module 740, and informs disc presence waiter module 740 of the change in disc presence status reported by disc reader 712.

With reference now to step 782, disc presence waiter module 740 reports a change in disc presence status to disc presence monitor module 734.

With reference now to step 784, disc presence monitor module 734 signals OSD task module 736 that a change in disc presence has been detected within the disc presence monitoring system.

With reference now to step 786, OSD task module 736 requests disc presence information from disc presence administration module 764. In some embodiments, OSD task module 736 requests disc information from disc presence administration module 764 regarding the particular disc required to initiate playback of the requested content. In some embodiments, if disc reader 712 was able to provide disc information during step 776, and if this disc information was provided to disc presence monitor 734, OSD task module 736 may be able to initiate playback of the requested content without further verification.

With reference now to step 788, disc presence administration module 764 responds to OSD task module 736 by indicating where the appropriate disc may be located, within the disc presence monitoring system.

With reference now to step 790, OSD task module 736 confirms disc presence information with disc presence agent module 714. In some embodiments, before playback may be initiated, it may be necessary to access the appropriate disc, e.g., to confirm the presence of the disc, or to obtain additional information necessary for playback of content.

With reference now to step 792, disc presence agent module 714 provides OSD task module 736 with the requested disc presence information. As noted above, in some embodiments, in addition to verifying disc presence, information may need to be retrieved from the corresponding disc in order to initiate playback of selected content. In several such embodiments, disc reader 712 may obtain this necessary information when a disc is inserted, and cache this information until it is requested by media player 732; in other embodiments, when this information is requested, disc reader 712 may need to access the information stored on the disc.

With reference now to step 794, OSD task module 736 initiates playback of the selected content. In some embodiments, disc presence monitoring continues during playback of the selected content; as discussed above, if the disc becomes unavailable during playback, different actions may be performed by media player 732.

For example, once playback begins, disc presence administration module 764 will again block the subscription request of disc presence waiter module 740. Thereafter, if reader application admin module 716 detects disc ejection, it will notify disc presence agent 714, which will update disc presence administration module 764, which will unblock the subscription notification request from disc presence waiter module 740 and notify module 740 of the change in disc status. Module 740 will report the change in disc status to disc presence monitor module 734, which will notify OSD task module 736. OSD task module 736 may pause or terminate playback, and display a notification to the user that the disc has been removed, and should be returned to disc reader 712, in order for playback to continue.

In other embodiments, other approaches for implementing a disc monitoring system may be utilized. For example, in one embodiment, disc presence is checked only when a playback request is received. This approach simplifies disc presence monitoring, but results in delay whenever access to content is requested; rather than maintaining a list of discs which are currently available, every available disc in every available disc reader or disc vault must be polled whenever content is requested. In another embodiment, disc presence administration modules are used to monitor and respond to disc presence information queries, with each disc presence administration module monitoring disc presence for a portion of a media server environment. This approach offers an advantage if a media server should become unavailable, in that the content rendered unavailable on the unavailable media server corresponds to the disc presence information provided by the disc presence administration module for that media server. However obtaining a complete list of disc presence information may require polling multiple disc presence administration modules. Also, this approach may necessitate that media players and their corresponding disc presence agents know which disc presence administration module to request this information from, for a specific piece of content. In another embodiment, the entire set of disc presence information may be replicated across multiple disc presence administration modules, if there are multiple media servers in the cluster. In this approach, polling is not required to reestablish the list of present discs when a new disc presence administrator becomes active.

### Disc Vault

As discussed above, in some embodiments, it may be desirable to ensure the presence of a physical media object before allowing access to the copy of the content associated with that physical media object on the media server. In some such embodiments, a multidisc storage unit, or disc vault, is a useful addition to a media server environment. Such a disc vault allows for storage of multiple physical media objects in a relatively limited space. Moreover, in some embodiments, the disc vault may also include an appropriate optical drive, which may allow for identification of media objects and/or importation of media objects in bulk. Additionally, in several embodiments, the disc vault may also incorporate media server and/or media player functionality.

In embodiments where ensuring the presence of a particular media object is desirable, an approach similar to the disc presence monitoring system and method described above may be utilized; alternatively, another approach may be used. Further, in order to hinder attempts to remove physical media, a disc vault may include case intrusion detection technology: if the case of the vault is opened, e.g., while the vault is unpowered or disconnected from the network, the vault should conduct an audit of the physical media objects currently stored in the vault, when power or connectivity is restored; alternatively, the media server may instruct the vault to perform such an audit.

Additionally, in some embodiments, such an audit may be periodically conducted without detection of a case intrusion.

With reference to FIG. 4, disc vault 472 is depicted as including Blu-ray optical drive 474 and carousel mechanism 488. In the depicted embodiment, carousel mechanism 488 can rotate to insert any selected disc, such as disc 476, into optical drive 474. Optical drive 474 can be used to read data from a selected disc, which can be used to identify a particular disc, e.g., determining an identifier such as a calculated hash value, or to import the content of the selected disc. In some embodiments, operation of disc vault 472 is controlled by media server 462. In other embodiments, disc vault 472 may also incorporate control elements capable of performing some of these tasks.

In some embodiments, as discussed above, additional information located on a particular disc may be required in order to initiate playback of content stored on a media server. In some such embodiments, this information is read by the disc vault when the particular disc is inserted into the vault; this information is then cached in the vault, or placed in storage available to the vault and/or the media server, until it is needed for playback. In one such embodiment, this information is deleted if the disc is removed from the vault.

With reference now to FIG. 8, a flowchart 800 of a method of utilizing a disc vault is depicted, in accordance with one embodiment. Although specific steps are disclosed in flowchart 800, such steps are exemplary. That is, embodiments of the present invention are well suited to performing various other (additional) steps or variations of the steps recited in flowchart 800. It is appreciated that the steps in flowchart 800 may be performed in an order different than presented, and that not all of the steps in flowchart 800 may be performed.

With reference now to step 801, one or more physical media objects are inserted into a vault. In some embodiments, physical media objects may include Blu-ray discs, DVDs, CDs, or any of the many variants of these formats. In different embodiments, different mechanisms for inserting discs into the vault may be utilized; similarly, the physical characteristics of the vault may vary across different embodiments. Such physical characteristics include, but are not limited to: capacity; layout; disc access method; and presence, number, positioning, type, and/or orientation of optical drives.

For example, with reference to FIG. 4, discs 476, 478, and 479 are inserted into disc vault 472.

With reference now to step 810, the physical media objects are identified. In some embodiments, each of the newly-inserted discs is cycled through an available optical drive, and an identification method, such as calculating an identifier, is utilized in order to identify each disc. In some embodiments, the vault, or the media server controlling the vault, is capable of determining a particular location within the vault for each physical media object inserted there in. Consequently, once a disc has been identified, that identity can be associated with a specific location within the vault; this allows for ease in auditing, accessing a particular disc, or selectively ejecting a particular disc. If content is currently being imported when new media objects are inserted, the ongoing importation operation may or may not be allowed to conclude, before the new media objects are identified.

Continuing the preceding example, carousel mechanism 488 cycles disc 476 to optical drive 474. Disc 476 is inserted, and a hash value is calculated, which media server 462 can use to identify disc 476. Disc 476 is then returned to carousel mechanism 488, which allows discs 478 and 479 to proceed through the same cycle.

With reference now to step 820, the content stored on physical media objects is imported, if it is not already present on the media server. In some embodiments, the vault can be used to import one or more media objects. In one such embodiment, a disc is loaded into an optical drive and the vault, and the contents can be copied to a media server in the media server environment, in a manner as described above.

In some embodiments, the order of steps 810 and 820 may vary. For example, in one embodiment, every newly inserted media object is identified, before any importation begins; this allows the media server to identify and locate every media objects stored in the vault faster, as identification takes much less time than importing content. In such an embodiment, it may be desirable to allow the last unidentified media object to be the first media object imported, as this will reduce the number of physical operations which occur. Alternatively, content may be imported in the order it was loaded into the vault, or in any other order which is desirable. In other embodiments, identification and importation may occur for each media object in turn; this requires fewer physical operations, in terms of changing discs.

Continuing the preceding example, as disc 479 is the last disc which needed to be identified, it remains in optical drive 474 and the content is imported to media server 462, where it is stored as image 466. Once import of disc 479 is complete, carousel mechanism 488 cycles disc 478 into optical drive 474, where it is imported, followed by disc 476.

With reference now to step 830, the presence of the media objects is reported to the media server. As discussed above, in some embodiments, it is desirable that the media server be aware of the absence or presence of a particular media object within the media server environment. As such, after a media object has been identified, its presence should be reported to the media server. In one embodiment, while a media object is stored in the vault, it is unusable; accordingly, the media server makes a corresponding copy stored on the media server usable. In different embodiments, disc presence reporting may occur at different times; for example, the vault may report the presence of a particular disc after it has been identified, but before importation; alternatively, the vault may report the presence of a particular disc only after it has been imported. In some embodiments, disc presence reporting may occur simultaneously with identification: when the vault reports the identifier being used to identify a particular media object, the media server is made aware that the media object is currently stored in the vault.

Continuing the preceding example, vault 472 reports the presence of discs 476, 478, and 479 to media server 462. Media server 462 is made aware that these discs are currently in the vault, and hence unusable; the corresponding images of the content of these discs can therefore be indicated as usable.

With reference now to step 840, the vault monitors the presence of the media objects stored therein. Any changes in the availability of media objects within the vault are reported to the media server. As discussed above, in some embodiments it is desirable that the media server be kept aware of the presence or absence of particular media objects. In different embodiments, this monitoring may occur in different ways; one embodiment uses the approach outlined above for disc presence monitoring.

Continuing the preceding example, vault 472 monitors the presence of the discs stored therein, including discs of 476, 478, and 479. Should the status of any of these discs change, vault 472 will notify media server 462.

With reference now to step 850, a media object ejection command is received by the vault. Upon receiving such a command, in some embodiments, the vault ejects the requested media object. In different embodiments, different approaches allow for issuing such an ejection command. In one embodiment, for example, the vault includes a front panel control mechanism which allows individual media objects to be selected and ejected; another embodiment includes a control mechanism which allows for ejection of every media objects stored in the vault; yet another embodiment utilizes a user interface, e.g., via a media player or a browser-based utility, to allow selection and ejection of specific media objects; other embodiments utilize other approaches.

Continuing the preceding example, vault 472 receives a command instructing it to eject disc 479. Carousel mechanism 488 rotates disc 479 to the required location for ejection, and disc 479 is ejected.

With reference now to step 855, the vault reports the change in media object presence which resulted from the ejection command to the media server. As discussed above, the presence of a media object within the media server environment may affect the availability of content stored on the media server. As such, when the contents of the vault change, the media server should be made aware, so that the media server may perform any necessary action resulting from the change in presence.

Continuing the preceding example, vault 472 informs media server 462 that disc 479 has been ejected. Accordingly, media server 462 flags image 466, which corresponds to disc 479, as being unusable. Media players within media server environment 400 will not be able to access the content associated with image 466, so long as disc 479 is not present within environment 400. If disc 479 is reinserted into vault 472, or any other appropriate optical drive within environment 400, media server 462 can make image 466 usable again.

With reference now to step 860, the vault detects that a case intrusion has occurred. As discussed above, in some embodiments the vault may incorporate case intrusion detection technology. If the vault is constructed in such a manner that the case may be removed in order to access or remove the media objects stored therein, the inclusion of case intrusion detection technology allows the vault to note when such access may have occurred. One having skill in the art will appreciate that such technology is well known, and operates in a manner to detect case intrusion even while the system is unpowered; such an intrusion is reported when next the system is powered on.

Continuing the preceding example, vault 472 incorporates case intrusion detection technology. If the case or access panel to vault 472 is removed, the case intrusion detection technology will inform vault 472 that such an event has occurred.

With reference now to step 865, the media objects stored in the vault are audited. As previously discussed, in some embodiments it is desirable to be aware of the presence or absence of media objects within the media server environment. Accordingly, if the cover on the vault has been removed, it may be necessary to identify every media object present in the vault, in order to determine whether a media object has been removed. In some embodiments, the vault may also report to the media server that such an audit is necessary; the media server may or may not make content associated with the media objects believed to be stored in the vault unusable until the audit is concluded.

Continuing the preceding example, vault 472 informs media server 462 that a case intrusion has occurred; media server 462 makes content associated with the discs stored in vault 472, such as image 466, unusable. Vault 472 performs an audit of the discs currently stored therein; carousel mechanism 488 delivers each disc in turn to optical drive 474, where it is identified. The vault 472 reports the presence of each disc, in a manner similar to step 830. Media server 462 makes the images associated with discs still stored in vault 472 usable again.

### Limiting Import of Selected Content

In some embodiments, it is desirable to prevent or delay importation of certain content under specific circumstances. A particular media object may be intended for distribution only to certain destinations, or may only be available to certain users for a specified length of time. As an example, a specific printing of a DVD or Blu-ray disc may only be available to movie rental stores for a certain length of time, before the rental stores are allowed to sell their copies to the general public. In such cases, users of a media server may be prevented from importing a media object until that media object is available to the general public. In one such embodiment, where rental discs can be identified, this would inhibit importation of rental content during an exclusive “rental only” period.

Limiting importation in this matter may be approached in different ways. One approach is to use a list of restricted content, such as a list of media objects which have been identified as “rental only.” In order to populate such a list, a database of these “rental only” media objects would need to be gathered; the database may include identifiers, such as a hash value calculated from certain data on the disc, or any other approach to distinguish between printings of media objects. One consideration is to avoid a scenario in which a user is prohibited from importing content, because it has been falsely identified as a “rental only” copy. Generally, this should not be a problem, as a rental copy of a movie should be a different “pressing” from a retail copy, which will result in different hash values.

A different approach to restricting importation would be to use a “flag” data field on the media object. For example, a Blu-ray disc or DVD may include a single bit field which identifies a rental disc, as opposed to a retail desk.

In some embodiments, another consideration is that a user should be able to import content legitimately purchased on the second hand market. For example, it is common for a movie rental stores to initially stock many copies of a popular movie; after the initial release window, the store will often sell off most of their copies of the movie. As such, preventing importation of “rental only” content should be limited to a specified prohibited timeframe, such as an initial rental release window; after this prohibited timeframe has elapsed, users should be allowed to import the previously “rental only” copies.

In some embodiments, a situation may occur where a prohibited media object, such as a “rental only” disc, is imported into a media server. This may occur if the prohibited media object is imported before the list of prohibited media objects has been updated to include the prohibited media object, or if importation occurs while the media server is unable to obtain an updated list of prohibited media objects from a remote server, or for some other reason. In some such embodiments, when an updated list of prohibited media objects is obtained, it is compared with the content currently stored on media server; if any copies of prohibited media object content are detected, the prohibited media object content may be deleted from the server, or the prohibited media object content may be made unavailable or unusable until the expiration of the prohibited timeframe.

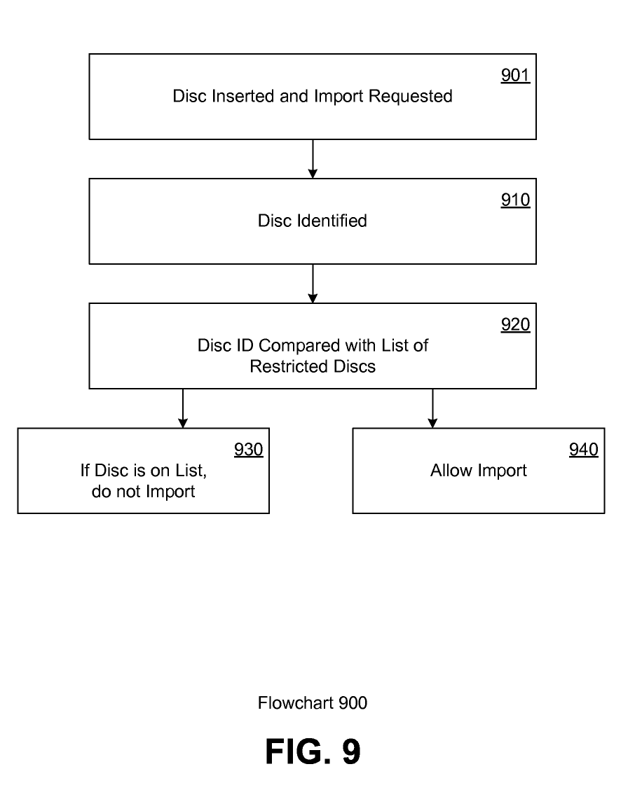

With reference now to FIG. 9, a flowchart 900 of a method of importing digital content is depicted, in accordance with one embodiment. Although specific steps are disclosed in flowchart 900, such steps are exemplary. That is, embodiments of the present invention are well suited to performing various other (additional) steps or variations of the steps recited in flowchart 900. It is appreciated that the steps in flowchart 900 may be performed in an order different than presented, and that not all of the steps in flowchart 900 may be performed.

With reference now to step 901, a media object is inserted into a media player, and importation of the media object is requested. In some embodiments, as discussed above, media objects can be imported to media servers in a media server environment.

For example, with reference to FIG. 4, disc 446 is inserted into DVD optical drive 444 of DVD player 442, and importation of disc 446 to media server 462 is requested.

With reference now to step 910, the media object is identified. In different embodiments, media object identification is achieved in different ways. In one embodiment, an identifier, such as a hash value, is calculated from content stored on the media object, and compared with an available database of similar identifiers, either stored within the media server environment, or located on some remote server.

Continuing the preceding example, media server 462 calculates a hash value for disc 446, in order to identify disc 446. Media server 462 accesses head end server 480 via network 411 and Internet 490, and consults metadata database 484 to attempt to find a match for the calculated hash value.

With reference now to step 920, the identified media object is checked against a list of restricted or prohibited media objects. In different embodiments, the step is implemented in different ways. In some embodiments, the identity of the media object is compared with a list of media objects for which importation is to be denied or restricted. Media objects may appear on this list for variety of reasons, such as the media object being identified as a “rental only” media object, or the media object being of the wrong media type, e.g., recognized commercial content on DVD-ROMs may be imported, but recognized commercial content on DVD-Rs may not be. This list may also include a date or duration entry associated with a restricted media object, indicating when the restriction will end. This list may also include an entry associated with a restricted media object, indicating the reason why import is restricted or prohibited. In another embodiment, the identified media object may be checked against a list of “permitted” content. For example, an agreement may exist with a first content provider or distributor, allowing import of some or all of the content under their control, while no agreement exists with a second content provider; only content from the first provider would appear on such a “permitted” list. In some embodiments, a determination is made as to whether to allow or prevent import of the media object, based on the result of checking such a list.

Continuing the preceding example, media server 462 compares the hash value of disc 446 against a list of restricted media objects obtained from metadata database 484.

With reference now to step 930, if the identified media object appears on the list of restricted or prohibited media objects, import of the media object is prevented. In different embodiments, preventing import may occur in different ways. For example, the media server in the media server environment may prevent import of the media object directly. In a different embodiment, the media server may instruct the media player currently containing the disc to stop importation. In some embodiments, a message may also be displayed, indicating that import of the media object has been denied, and potentially including a reason for prevention of the import and/or a date when import will be allowed. In another embodiment, the identified media object may be imported, but access to that content may be inhibited. For example, the content may be unusable until a certain date, or access to portions of the content, such as a trailer, may be permitted, while access to other portions is denied.

Continuing the preceding example, if the hash value for disc 446 appears on the list obtained from metadata database 484, media server 462 instructs DVD player 442 to prevent importation of disc 446.

With reference now to step 940, if the identified media object does not appear on the list of restricted or prohibited media objects, the media object is imported to the media server. As previously discussed, importation of media objects may be implemented in different ways in different embodiments.

Continuing the proceeding example, if the hash value for disc 446 does not appear on the list obtained from metadata database 484, the media server 462 instructs DVD player 442 to import disc 446.

Embodiments of the present invention are thus described. While the present invention has been described in particular embodiments, it should be appreciated that the present invention should not be construed as limited by such embodiments, but rather construed according to the following claims.

What is claimed is:

1. A method, comprising:
receiving a request for access to digital content; and
verifying a location of a disc associated with said digital content.

2. The method of claim 1, further comprising:
initiating playback of said digital content.

3. The method of claim 2, further comprising:
monitoring said location of said disc during said playback.

4. The method of claim 1, further comprising:
accessing said disc, in order to obtain specific information necessary for said access to said digital content.

5. The method of claim 1, further comprising:
inserting said disc into a disc reader.

6. The method of claim 1, further comprising:
copying said digital content from said disc to a storage location.

7. The method of claim 6, wherein said copying comprises performing a “move” process of said digital content from said disc to said storage location, such that said disc or said digital content on said storage location cannot be accessed in usable form by another product, except as and when passed to an output.

8. A system, comprising:
an optical drive; and
a media server, comprising a storage device, and coupled to said optical drive,
wherein said media server is configured to determine whether said optical drive contains an optical disc associated with digital content, and is further configured to receive a request for access to said digital content.

9. The system of claim 8, further comprising:
a media player, coupled to said media server,
wherein said media player is configured to receive a user request for access to said digital content, and to transmit said request for said digital content to said media server.

10. The system of claim 9, wherein said media player comprises said optical drive.

11. The system of claim 9, wherein said media player is further configured to output said digital content to a display device.

12. The system of claim 8, further comprising:
a plurality of media players, coupled to said media server,
wherein each of said plurality is configured to transmit requests for access to said digital content to said media server.

13. The system of claim 8, further comprising:
a disc vault, comprising said optical drive and coupled to said media server,
wherein said disc vault is configured to hold a plurality of optical discs, and to inform said media server of a location of each of said plurality of optical discs.

14. The system of claim 8, wherein said digital content comprises a copy of content stored on said optical disc.

15. The system of claim 8, wherein said optical disc comprises a Blu-ray disc.

16. A method of disc presence monitoring, comprising:
detecting a change in a presence state associated with a media object; and
updating a list of presence state information, with reference to said change in said presence state associated with said media object.

17. The method of claim 16, further comprising:
receiving a request for access to digital content associated with said media object; and
determining whether to allow said request, with reference to said list of presence state information.

18. The method of claim 17, wherein said determining comprises:
allowing said request, if said list of presence state information indicates that said media object is present.

19. The method of claim 16, further comprising:
distributing said list of presence state information.

20. The method of claim 16, wherein said detecting comprises detecting insertion of said media object; and
wherein said method further comprises:
identifying said media object.

21. A method, comprising:
receiving a request to import a disc;
making a determination as to whether said disc should be imported; and
responding to said request, with reference to said determination.
